(19) United States
(12) Patent Application Publication
(10) Pub. No.: US 2013/0144514 A1
(43) Pub. Date: Jun. 6, 2013

(54) SYSTEM AND METHOD FOR CONTROLLING ENGINE OF HYBRID VEHICLE

(71) Applicants: Yong Kak Choi, Anyang (KR); Il Kwon Park, Goyang (KR); Chae Mo Yang, Gunpo (KR)

(72) Inventors: Yong Kak Choi, Anyang (KR); Il Kwon Park, Goyang (KR); Chae Mo Yang, Gunpo (KR)

(73) Assignees: KIA MOTORS CORPORATION, Seoul (KR); HYUNDAI MOTOR COMPANY, Seoul (KR)

(21) Appl. No.: 13/547,458

(22) Filed: Jul. 12, 2012

(30) Foreign Application Priority Data
Dec. 6, 2011 (KR) 10-2011-0129699

(51) Int. Cl. F02D 28/00

(52) U.S. Cl. 701/113; 180/65.28; 903/902

(57) ABSTRACT

Disclosed is a system and method for controlling an engine of a hybrid vehicle that continuously detects an output required power with the engine of the hybrid vehicle in an Off state, and determines whether the required power exceeds a preset engine delayed ignition power. Then a determination is made as to whether the required power exceeds a preset engine non-delayed ignition power; and when the required power exceeds the engine non-delayed ignition power within a first set time starting the engine, after the required power exceeds the engine delayed ignition power, so that the fuel efficiency and the output efficiency of a hybrid vehicle according to the present invention may be improved.

### CROSS-REFERENCE TO RELATED APPLICATION

This application claims priority to and the benefit of Korean Patent Application No. 10-2011-0129699 filed in the Korean Intellectual Property Office on Dec. 6, 2011, the entire contents of which are incorporated herein by reference.

### BACKGROUND OF THE INVENTION

(a) Field of the Invention

The present invention relates to a system and method for controlling the engine of a hybrid vehicle, and more particularly, to a method for controlling the engine of a hybrid vehicle, which is capable of improving output efficiency and fuel efficiency of the vehicle by controlling the ignition point of the engine.

(b) Description of the Related Art

A hybrid vehicle is propelled by two power sources, i.e., typically a motor and an engine, and is generally driven by the motor in a range where the power required by a driver (i.e., determined based on the depth of the accelerator pedal) is low such as at slow speeds. On the other hand, at high speeds, during acceleration, while climbing, etc., when the large amount of power is required by the driver, the engine is operated so as to output power simultaneously from the engine and the motor to drive the vehicle.

The vehicle's energy efficiency is changed according to the points at which the engine is switched on and off during driving. Accordingly, by effectively determining the engine on point, the fuel efficiency of the vehicle can be improved.

In some hybrid vehicles, as illustrated in FIG. 1, when the power required by a driver according to the accelerator pedal is in a low range, the vehicle is driven in an electric vehicle (EV) mode using a just the electric motor, and when the power required by the driver becomes greater and exceeds a certain reference P2, the engine is operated to drive the vehicle in hybrid mode in which the engine and the motor are simultaneously operated. When the power required by the driver drops to below a certain hysteresis P1, the engine is turned off, and the vehicle is driven in EV mode.

During stop-and-go driving such as city driving in which the driver frequently presses the accelerator pedal, as illustrated in FIG. 1, the engine on/off is performed frequently. Several seconds is required to activate the engine in order to smoothly transfer engine power to the drivetrain to drive the vehicle, and when the engine is turned off at this point, the engine power does not contribute to providing torque to the output shaft. Thus, if the engine is not turned on and off efficiently and effectively while driving in the city, a low fuel efficiency may result do to the amount of energy that is required to start and stop the engine.

Further, once the engine is started, even if the driver were to immediately take his or her foot off the accelerator, the ignition is still left on with the engine idling for several seconds in preparation for re-acceleration and for the sake of drivability, whereupon fuel is consumed necessarily in most cases, resulting in diminished fuel efficiency.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a system and method for controlling the engine of a hybrid vehicle, which can improve the fuel efficiency of the vehicle by preventing the consumption of fuel and the waste of electrical energy from needlessly turning the engine on/off, which can reduce the amount of generated toxic fumes, and which can improve the output efficiency of the vehicle.

An exemplary embodiment of the present invention provides a system and method for controlling the engine of a hybrid vehicle. In exemplary embodiments the method for controlling the engine of a hybrid vehicle includes: (a) continuously detecting an output required power when the engine of the vehicle in an Off state, and determining whether the required power exceeds a preset engine delayed ignition power; (b) determining whether the required power exceeds a preset engine non-delayed ignition power; and (c) starting the engine when the required power exceeds the engine non-delayed ignition power within a first set time, after the required power exceeds the engine delayed ignition power.

In some embodiments of the present invention, when the required power is greater than the engine delayed ignition power and less than the engine non-delayed ignition power, the engine may be started after the first set time elapses.

The system and method for controlling an engine of a hybrid vehicle may further include the step of (d) calculating a required power change amount (slope) over a period of time at a point when the first set time has elapsed, and using the calculated required power change amount to determine whether to start the engine. When the required power change amount is greater than 0, the engine may be started. When the required power change amount is 0, the engine may be started after a second set time elapses. When the required power change amount is less than 0, ignition of the engine may be kept Off.

After the first set time, when the required power increases and exceeds the engine non-delayed ignition power before the second set time elapses, the engine may be started. After the first set time elapses and before the second set time elapses, when the required power change amount becomes less than 0, the second set time may be reset to 0. After the second set time is reset to 0, when the required power becomes less than the engine delayed ignition power, the first set time and the second set time may be reset to 0. After the second set time is reset to 0, when the required power exceeds the engine delayed ignition power, the step (d) may be repeated.

The method for controlling an engine of a hybrid vehicle may further include (e) when the required power exceeds a preset engine Off power after the engine is started, the engine is kept on, and when the required power is less than the preset engine Off power after the engine is started, the engine is turned Off.

According to the method for controlling the engine of a hybrid vehicle of the present invention, by flexibly controlling the engine ignition time according to the amount of required power, consumption of fuel and electrical energy waste due to needless on/off of the engine may be prevented, and the fuel efficiency of the vehicle may be improved. Further, according to the present invention, needless on/off of the engine may be prevented to reduce the amount of generated toxic gas and to also improve the output efficiency of the vehicle.

### BRIEF DESCRIPTION OF THE DRAWINGS

FIG. 1 is a graph illustrating engine control according to the related hybrid vehicle.

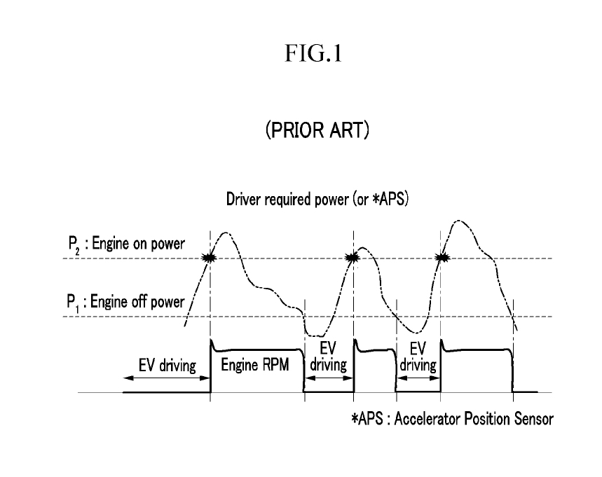

FIG. 2 is a diagram illustrating an exemplary embodiment of a hybrid system applied to the present invention.

FIG. 3 is a flowchart of a method for controlling an engine of a hybrid vehicle according to an exemplary embodiment of the present invention.

FIG. 4 is graph of a method for controlling an engine according to an exemplary embodiment of the present invention.

FIG. 5 is a graph of a method for controlling an engine according to another exemplary embodiment of the present invention.

FIG. 6 is a diagram comparing control graphs of the present invention and the related art.

FIG. 7 is a graph in which a method for controlling an engine of the present invention is actually applied and tested.

### DETAILED DESCRIPTION OF THE EMBODIMENTS

Hereinafter, exemplary embodiments of the present invention will be described in detail with reference to the drawings.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Furthermore, control logic executed by the control units of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Although the below exemplary embodiments are described as using a plurality of units to perform the above process, it is understood that the below processes may also be performed by a single controller or unit.

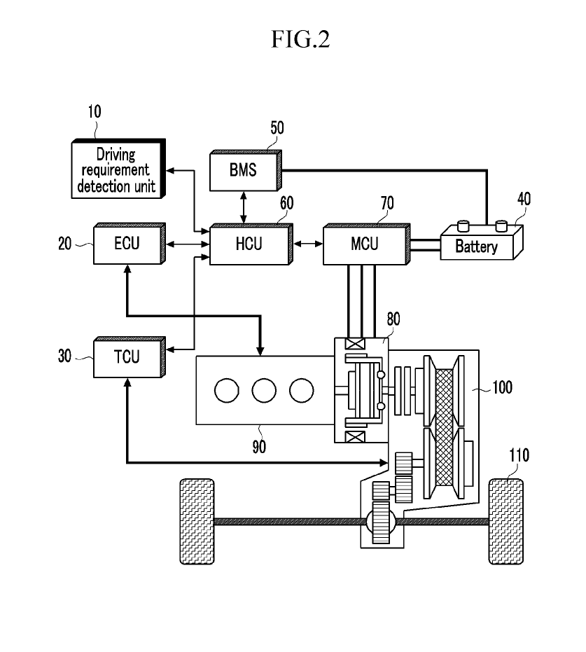

FIG. 2 is a diagram schematically illustrating a hybrid system applied to a method for controlling the engine of a hybrid vehicle according to an exemplary embodiment of the present invention. For descriptive convenience, the hybrid system of FIG. 2 has been illustrated as an exemplary embodiment. Accordingly, a method for controlling the engine of a hybrid vehicle according to an exemplary embodiment of the present invention may be applied not only to the hybrid system of FIG. 2, but to all other hybrid systems.

The hybrid system to which the present invention is applied, as illustrated in FIG. 2, may include a driving requirement detection unit 10 and an engine control unit (ECU) 20, a battery 40, a battery management system (BMS) 50, a hybrid control unit (HCU) 60, a motor control unit (MCU) 70, a motor 80, an engine 90, a transmission 100, and drive wheel 110.

The driving requirement detection unit 10 may be configured to detect the vehicle's driving requirements (e.g., the vehicle's required power) received from a driver, and detect a start and an accelerator position sensor (APS) signal, a brake pedal signal, shift information (P/R/N/D/E/L) selected with a shift lever, etc., and output information corresponding thereto. Hereinafter, required power will be described mainly with respect to the APS.

The ECU 20 may be configured to control the overall operation of the engine 90 according to the driving requirement (required power) signal from the driving requirement detection unit 10, a coolant temperature, and engine torque and other engine state information.

The battery 40 supplies a voltage to the motor 80 in hybrid mode, and recovers and stores regenerative braking energy during stopping and while being charged. The BMS 50 integrally detects information related to the voltage, current, temperature, etc. of the battery 40 to manage and control the state of charge (SOC) state of the battery 40, and control an amount of current supplied according to the output torque from the motor 80.

The HCU 60 may be a priority controller that controls the overall operation of the hybrid vehicle, and connects a controller to a network for each device and provides and receives information therebetween, and performs collaborative control to control the output torque from the engine 90 and the motor 80 and control a target gear ratio while the vehicle is being operated. This hybrid system is widely known to persons of ordinary skill in the art, and thus, a detailed description on each element will not be provided.

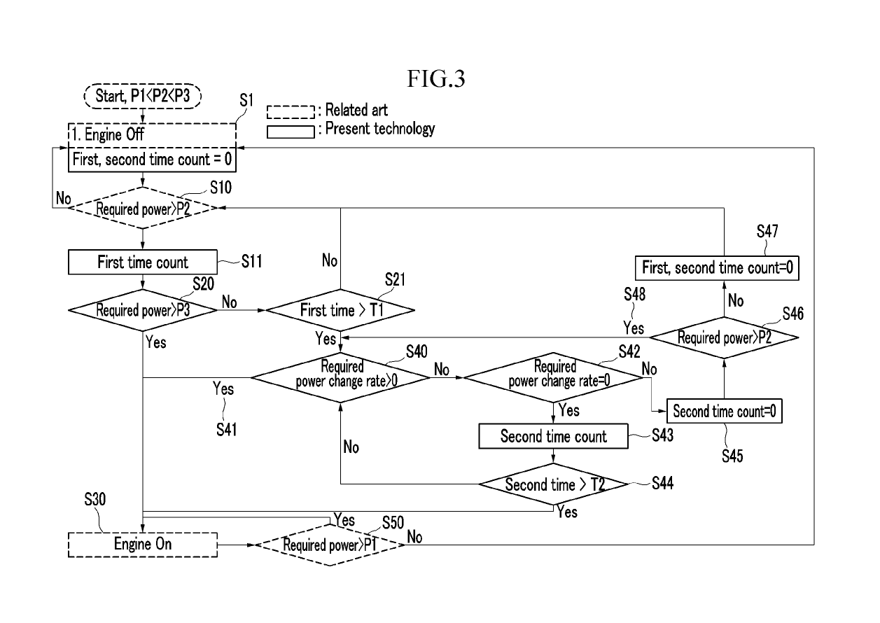

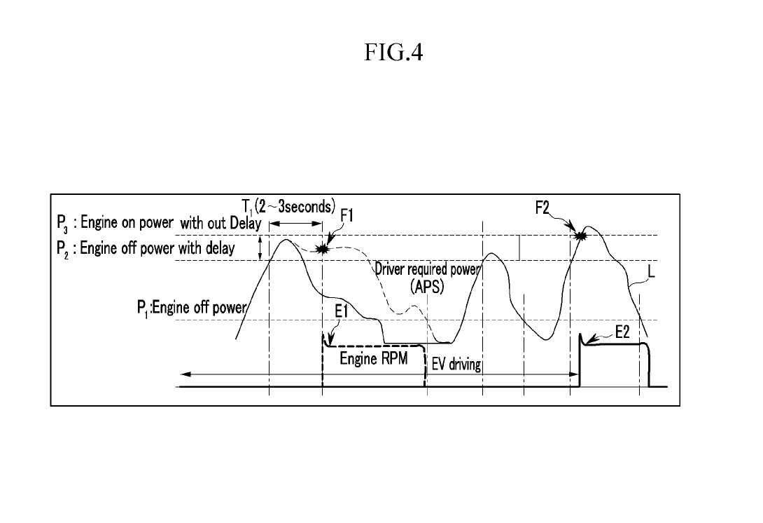

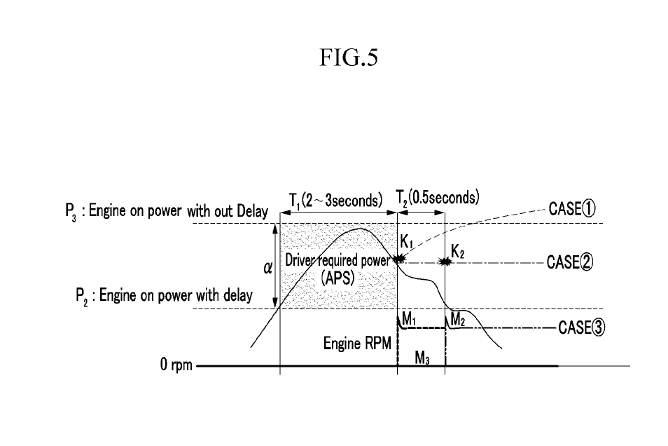

FIG. 3 is a flowchart of a method for controlling an engine of a hybrid vehicle according to an exemplary embodiment of the present invention, and FIGS. 4 and 5 are graphs illustrating required power changes of an engine over time. Referring to FIGS. 3 and 4, when the ignition of the engine 90 is in an off state as in electric vehicle (EV) mode, the vehicle ECU 20 or the HCU 60 continuously detects an output required power of the vehicle in step S1, and determines in step S10 whether the required power exceeds a preset engine delayed ignition power P2.

In one or a plurality of embodiments, the required power of the engine may be determined through a sensing APS signal detected by the driving requirement detection unit 10 by based on the degree at which the accelerator pedal is pressed by the driver. Also, when the required power exceeds the engine delayed ignition power P2, a first time count is initiated in step S11 as illustrated in FIG. 3.

Meanwhile, the vehicle ECU 20 or the HCU 60 may determine whether the required power exceeds a preset engine non-delayed ignition power P3 in step S20. As illustrated in FIGS. 4 and 5, the engine non-delayed ignition power P3 is set as a value greater than the engine delayed ignition power P2. Also, the engine off power P1 is set as a value less than the engine delayed ignition power P2.

While the related art is based only on the engine non-delayed ignition power P3 and the engine off power P1, the present invention adds the engine delayed ignition power P2 thereto.

After exceeding the engine delayed ignition power P2, when the required power exceeds the engine non-delayed power P3 within a first set time, the vehicle ECU 20 or the HCU 60 may immediately turn on the engine in step S30. That is, point F2 on the required power line L of FIG. 4 corresponds to this action (point in time). The required power at point F2 becomes greater than the engine delayed ignition power P2 and the engine non-delayed ignition power P3, and at this point F2, the engine 90 is immediately started so that the RPM equals E2. When the required power is greater than the engine delayed ignition power P2 and less than the engine non-delayed ignition power P3, the vehicle ECU 20 or the HCU 60 determines in step S21 whether the counted first time has surpassed the first set time T1.

In one or a plurality of embodiments, when the counted first time surpasses the first set time T1, the vehicle ECU 20 or the HCU 60 immediately starts the engine 90. Point F1 illustrated in FIG. 4 which corresponds to this case. That is, according to an exemplary embodiment of the present invention, when the required power exceeds only the engine delayed ignition power P2, the engine 90 is not immediately started, but the engine 90 is started after a delay by the predetermined first set time T1. Accordingly, the peak value of the required power of the driver is absorbed in order to prevent frequent engine 90 on/off and improve the fuel efficiency of the vehicle.

Further, in another or a plurality of other embodiments, after step S21 as illustrated in FIG. 3, the vehicle ECU 20 or the HCU 60 may consider a change in the required power in steps S40 and S41. That is once the first set time has passed, the vehicle ECU 20 or the HCU 60 calculates a change in the amount of required power (the slope of required power in FIG. 4) over time, and uses the changed amount to determine in step S40 whether to turn the engine 90 on. The required power change amount is a curve of the required power changing over time, and is the amount of change in the slope of the acceleration pedal when an APS value.

When the required power change amount, that is, the slope of the required power is determined in step S41 to have a value greater than 0, the required power is in an increasing state, in which case the vehicle ECU 20 or the HCU 60 immediately starts the engine 90. This is Case 1 in FIG. 5, where the slope at point K1 is a positive value where the engine 90 is immediately started so that the RPM of the engine 90 is equal M1.

On the other hand, when the required power change amount, that is, the slope of the required power L in FIG. 4, is determined to have a value of 0 or have a value of less than 0 in step S42, the engine 90 is not immediately turned on. In this case, the vehicle ECU 20 or the HCU 60 counts a second time in step S43 and determines the two circumstances.

When the required power change amount (slope) is 0, the required power amount is maintained the same, so that when the counted second time reaches a second set time T2 in step S44, the vehicle ECU 20 or the HCU 60 starts the engine 90. This is Case 2 from among the cases illustrated in FIG. 5, and as illustrated in FIG. 5, after a delay of the second set time T2, the engine 90 is started at point K2. Accordingly, the RPM of the engine 90 appears at point M2.

Further, when the required power change amount (slope) is less than 0, this indicates that the required power amount is being reduced, in which case the vehicle ECU 20 or the HCU 60 resets the counted second time to 0 in step S45.

This may be Case 3 illustrated in FIG. 5. For Case 3, at point K1 where the first set time T1 has elapsed, the slope has a negative value, and the second time count is reset to 0 in step S45. Accordingly, even when the second set time T2 elapses, the engine 90 is not started at point M3.

As illustrated in FIG. 3, after the second set time is reset to 0, the vehicle ECU 20 or the HCU 60 determines in step S46 whether the required power falls below the engine delayed ignition power P2. When it is determined that the required power falls below the engine delayed ignition power P2, the first set time and the second set time are both reset to 0 and step S10 is repeated in step S47. When it is determined in step S48 that the required power exceeds the engine delayed ignition power P2, step S40 is repeated and it is determined whether the required power change amount has a positive value.

It is determined through step S46 that Case 3 in FIG. 5 is one in which the required power is less than the engine delayed ignition power P2, and step S47 is performed. After the engine 90 is started in step S30, S41, or S44, the vehicle ECU 20 or the HCU 60 determines in step S50 whether the required power exceeds a preset engine Off power P1. When the vehicle ECU 20 or the HCU 60 determines that the required power exceeds the preset engine Off power P1, the engine 90 is kept on, and when the required power falls below the engine Off power P1, the engine 90 is turned Off in step S50.

According to the system and method for controlling an engine of a hybrid vehicle according to an exemplary embodiment of the present invention as described above, when the required power exceeds P3, the engine is immediately started in order to provide the desired output level without delay by operating the engine at high power.

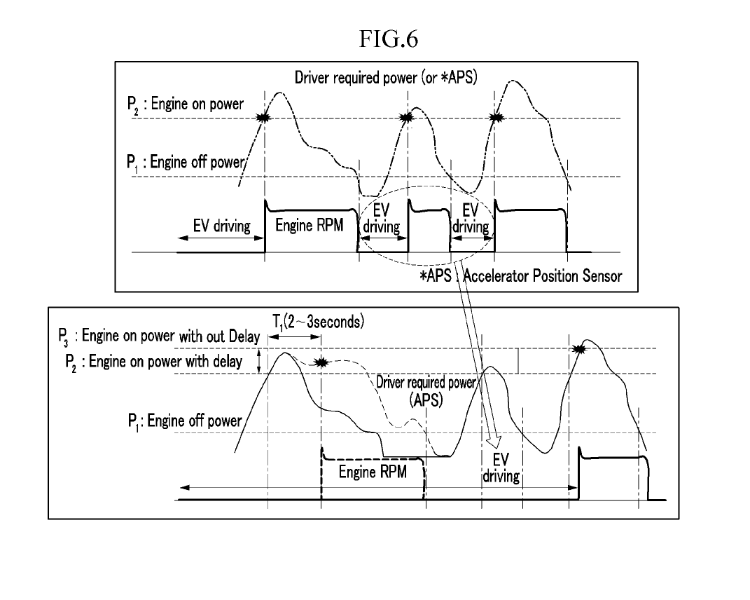

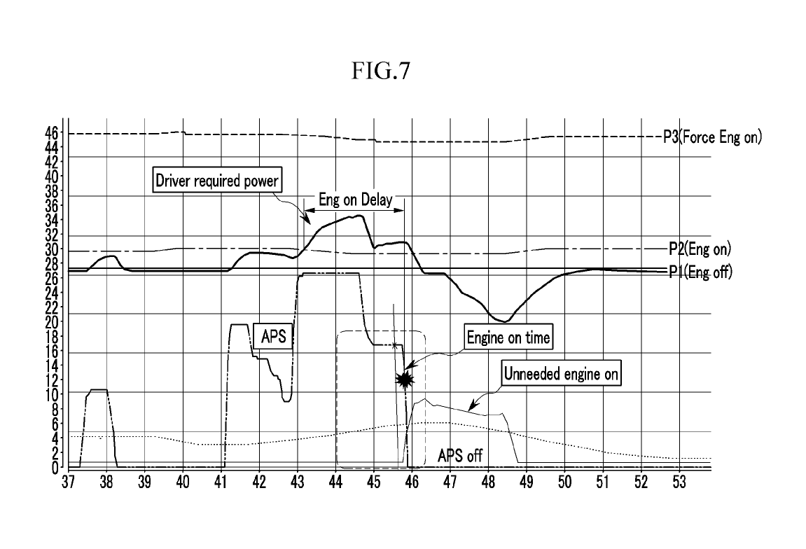

Further, referring to FIG. 6, when the required power of a driver is between P2 and P3, after a delay of a predetermined time T1, the engine is started so that unnecessary engine on/off in the related art may be prevented and fuel efficiency of the vehicle may be improved. When the required power of the driver is between P2 and P3, it is segmented further to control the ignition of the engine according to the required power change amount, in order to more precisely reduce the number of unnecessary engine on/offs. That is, as illustrated in FIG. 7, when the required power is between P2 and P3, after a delay of a predetermined time, the required power change amount (slope) is determined to prevent unnecessary engine ignition On when the slope has a negative value, and thus improve fuel efficiency of the vehicle.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

P1: Engine off power
P2: Engine delayed ignition power
P3: Engine non-delayed ignition power
T1: First set time
T2: Second set time

What is claimed is:

1. A method for controlling an engine of a hybrid vehicle, the method comprising:
(a) continuously, by at least one control unit, detecting an output required power with the engine of the vehicle in an Off state, and determining whether the required power exceeds a preset engine delayed ignition power;
(b) determining, by at least one control unit, whether the required power exceeds a preset engine non-delayed ignition power; and
(c) starting, by at least one control unit, the engine when the required power exceeds the engine non-delayed ignition power within a first set time, after the required power exceeds the engine delayed ignition power,
wherein the engine non-delayed ignition power is set as a value greater than the engine delayed ignition power.

2. The method for controlling an engine of a hybrid vehicle of claim 1, wherein:
when the required power is greater than the engine delayed ignition power and less than the engine non-delayed ignition power, the engine is started after the first set time elapses.

3. The method for controlling an engine of a hybrid vehicle of claim 2, further comprising:
(d) calculating, by at least one control unit, a required power change amount (slope) over time at a point when the first set time has elapsed, and using the calculated required power change amount to determine whether to start the engine.

4. The method for controlling an engine of a hybrid vehicle of claim 3, wherein:
when the required power change amount is greater than 0, the engine is started.

5. The method for controlling an engine of a hybrid vehicle of claim 3, wherein:
when the required power change amount is 0, the engine is started after a second set time elapses.

6. The method for controlling an engine of a hybrid vehicle of claim 3, wherein:
when the required power change amount is less than 0, ignition of the engine is kept Off.

7. The method for controlling an engine of a hybrid vehicle of claim 5, wherein:
after the first set time, when the required power increases and exceeds the engine non-delayed ignition power before the second set time elapses, the engine is started.

8. The method for controlling an engine of a hybrid vehicle of claim 5, wherein:
after the first set time elapses and before the second set time elapses, when the required power change amount becomes less than 0, the second set time is reset to 0.

9. The method for controlling an engine of a hybrid vehicle of claim 8, wherein:
after the second set time is reset to 0, when the required power becomes less than the engine delayed ignition power, the first set time and the second set time are reset to 0.

10. The method for controlling an engine of a hybrid vehicle of claim 8, wherein:
after the second set time is reset to 0, when the required power exceeds the engine delayed ignition power, the step (d) is repeated.

11. The method for controlling an engine of a hybrid vehicle of any one of claims 1 to 10, further comprising:
(e) when the required power exceeds a preset engine Off power after the engine is started, the engine is kept on, and when the required power is less than the preset engine Off power after the engine is started, the engine is turned Off.

12. A non-transitory computer readable medium containing program instructions executed by a processor or controller, the computer readable medium comprising:
program instructions that continuously determine whether the required power exceeds a preset engine non-delayed ignition power by continuously detecting an output required power with the engine of the vehicle in an Off state, and determining whether the required power exceeds a preset engine delayed ignition power; and
program instructions that start the engine when the required power exceeds the engine non-delayed ignition power within a first set time, after the required power exceeds the engine delayed ignition power,
wherein the engine non-delayed ignition power is set as a value greater than the engine delayed ignition power.

13. The non-transitory computer readable medium of claim 12, wherein:
when the required power is greater than the engine delayed ignition power and less than the engine non-delayed ignition power, the engine is started after the first set time elapses.

14. The non-transitory computer readable medium of claim 13, further comprising:
program instructions that calculate a required power change amount (slope) over time at a point when the first set time has elapsed, and using the calculated required power change amount to determine whether to start the engine.

15. The non-transitory computer readable medium of claim 14, wherein:
when the required power change amount is greater than 0, the engine is started.

16. The non-transitory computer readable medium of claim 14, wherein:
when the required power change amount is 0, the engine is started after a second set time elapses.

17. The non-transitory computer readable medium of claim 14, wherein:
when the required power change amount is less than 0, ignition of the engine is kept Off.

18. The non-transitory computer readable medium of claim 17, wherein:
after the first set time, when the required power increases and exceeds the engine non-delayed ignition power before the second set time elapses, the engine is started.

19. The non-transitory computer readable medium of claim 17, wherein:
after the first set time elapses and before the second set time elapses, when the required power change amount becomes less than 0, the second set time is reset to 0.

20. The method for controlling an engine of a hybrid vehicle of claim 19, wherein:
after the second set time is reset to 0, when the required power becomes less than the engine delayed ignition power, the first set time and the second set time are reset to 0.
